(19) United States
(12) Patent Application Publication
(10) Pub. No.: US 2025/0289947 A1
(43) Pub. Date: Sep. 18, 2025

(54) THERMOPLASTIC ELASTOMER COMPOSITION AND ARTICLE INCORPORATING IT, FOR EXAMPLE A HOSE

(71) Applicant: HUTCHINSON, PARIS (FR)

(72) Inventors: Charlène FOREST, VIMORY (FR); Fabien TAILLEBOIS, CEPOY (FR)

(73) Assignee: HUTCHINSON, PARIS (FR)

(21) Appl. No.: 19/077,173

(22) Filed: Mar. 12, 2025

(30) Foreign Application Priority Data
Mar. 13, 2024 (FR) FR2402517

(51) Int. Cl. C08L 23/12; C08K 5/18; C08K 5/3437; C08K 5/372; C08L 23/16; H01M 10/613; H01M 10/625; H01M 10/6568

(52) U.S. Cl. CPC C08L 23/12; C08K 5/18; C08K 5/3437; C08K 5/372; C08L 23/16; H01M 10/613; H01M 10/625; H01M 10/6568; C08K 2201/014; C08L 2201/08; C08L 2203/18; C08L 2205/025; C08L 2205/035; C08L 2205/06; C08L 2207/20; C08L 2312/00; H01M 2220/20

(57) ABSTRACT

A thermoplastic elastomer composition and an elastomer or elastomer-textile or metal composite article incorporating the composition. The composition includes (i) at least one elastomer, (ii) at least one polyolefin including a recycled polyolefin part and optionally a virgin polyolefin part, (iii) a reinforcing filler, (iv) a plasticising system, and (v) an antioxidant system. The composition includes, in mass fractions: more than 35% of the at least one polyolefin, and less than 30% of the plasticising system.

### CROSS-REFERENCE TO RELATED APPLICATIONS

This application is based upon and claims the benefit of priority from French Patent Application No. 2402517, filed Mar. 13, 2024, the entire contents of which is incorporated herein by reference.

### TECHNICAL FIELD

The invention relates to a thermoplastic elastomer composition, in particular usable in a single-layer or multi-layer hose, and an elastomer or elastomer-textile or metal composite article incorporating this composition. The invention especially applies to a single-layer or multi-layer hose, for example for a cooling circuit of a battery or an electric motor of a hybrid or electric automotive vehicle, it being specified that the invention generally relates to any elastomer or composite article comprising an elastomer material (including, but not limited to, gaskets, anti-vibration devices and any other elastomer element for example for battery packs or data processing centres) which is likely to equip a land (automobile or railway), water, air or space vehicle, as well as any industrial or residential facility.

### BACKGROUND

In a known manner, a hose for cooling circuit of automotive vehicle is most often based on rubber(s), and can be of:
the single-layer type, as for example in document FR 3130922 A1 in the name of the Applicant, which sets forth a hose without reinforcing core to convey a cooling fluid at no more than 2.5 10⁵ Pa and at most 110° C., consisting of a rubber layer based on an ethylene-propylene-diene terpolymer (EPDM), or
most often of the multi-layer type, comprising an inner rubber layer designed to be in contact with the cooling fluid, a reinforcing core e.g. textile reinforcing core overlying the inner layer, and at least one outer rubber layer overlying the reinforcing core, as in document U.S. Pat. No. 11,833,787 B2 in the name of the Applicant, which describes an inner layer based on EPDM, a textile reinforcing core, an outer layer based on ethylene-vinyl acetate (EVA) rubber and an intermediate layer based on a mixture of EPDM rubber with EVA rubber or with acrylic rubber of the polyacrylate (ACM) or ethylene-acrylate (AEM) type.

Recently, attempts have been made to use thermoplastic elastomers (TPE) instead of the aforementioned rubbers to manufacture liquid-conveying hoses, as described, for example, in document WO 2022/234351 A1, which discloses, for the manufacture of at least one layer of a reinforced or convoluted hose, the use of a TPE consisting of:

(A) 30-80% by weight of a polymeric matrix consisting of 10-35% of a first, thermoplastic, part (A1) and 20-45% of a second, elastomeric, part (A2) present in the TPE;
(B) 30-55% by weight of at least one plasticising agent;
(C) 0-30% of at least one filler;
(D) 0-10% of at least one additive;
the TPE having a Shore A hardness of 50-85, a PCR (post-consumer recycled) recycled material mass ratio of 50% or more, and the TPE being present in at least 90% of the total weight of the hose.

A major drawback of the hoses set forth in WO 2022/234351 A1 lies in the fact that they are specifically designed to form irrigation, watering or water transport hoses in a swimming pool or spa, and are not adapted to the operating conditions of a cooling circuit of an electric motor or a battery of an automotive vehicle (see especially the TPE-S and TPV respectively tested in tables 3 and 6 of WO 2022/234351 A1, free of reinforcing filler such as carbon black, which have breaking stress values well below minima required for single-layer hoses for such a cooling circuit).

Indeed, such a cooling circuit requires that the hose be resistant both mechanically and chemically to its electrochemical degradation on contact with the pressurised cooling fluid (usually glycol water) and its external environment (usually hot air), these requirements having to characterise the same layer in the case of a single-layer hose. In particular, a hose for this cooling circuit should have breaking properties that remain satisfactory, even after long-term thermal ageing in contact with air and glycol water.

Another drawback of the hoses set forth in WO 2022/234351 A1 is the relatively high amount of plasticiser used.

### SUMMARY

One purpose of the present invention is to provide a thermoplastic elastomer composition, especially able to form a single-layer hose for a cooling circuit of a battery or an electric motor of an electric or hybrid electric motor vehicle, the hose especially remedying the aforementioned drawbacks without compromising its extrusion implementability, nor its rheological properties, and having mechanical properties and resistance to thermal ageing in glycol water and in air sufficient to be able to resist chemically and mechanically to prolonged conditions of temperature and pressure adapted to the circulation of a cooling fluid.

This purpose is achieved in that the Applicant unexpectedly discovered that if, in a thermoplastic elastomer composition, an elastomer is combined with a sufficiently high amount of a polyolefin comprising a recycled part in the presence of a sufficiently reduced amount of a plasticising system, then a composition can be obtained which, via a reinforcing filler and an antioxidant system, is particularly well adapted to form a single-layer hose or an inner and/or outer layer of a multi-layer hose for the aforementioned cooling circuit, especially with satisfactory rheological, extrudability and flexibility properties and mechanical breaking properties even after said thermal ageing in glycol water and in air, and hence a satisfactorily durable dynamic performance in this cooling circuit.

More precisely, a thermoplastic elastomer composition according to the invention comprises:

(i) at least one elastomer,
(ii) at least one polyolefin comprising a recycled polyolefin part and optionally a virgin polyolefin part,
(iii) a reinforcing filler,
(iv) a plasticising system, and
(v) an antioxidant system, and said composition comprises, in mass fractions:
more than 35% of said at least one polyolefin, and
less than 30% of said plasticising system.

It will be noted that this combination of high and, conversely, reduced amounts, for the at least partly recycled polyolefin and for the plasticising system respectively, which goes against the technical prejudice for the person skilled in the art represented by the aforementioned WO 2022/234351 A1, particularly advantageously makes it possible to confer on the extruded composition at the same time satisfactory rheological, extrudability and further mechanical properties which can even be improved after thermal ageing, in comparison with the mechanical properties of a reference thermoplastic elastomer composition having a similar formulation but in which said at least one polyolefin is entirely virgin (i.e. is not at least partly recycled).

As a result, a composition according to the invention is particularly well adapted to form, by way of example and not limited to, not only a single-layer hose and an inner layer and/or an outer layer of a multi-layer hose, but also a gasket or an anti-vibration device.

It will also be noted that a thermoplastic elastomer composition according to the invention, which differs from the rubber compositions commonly used for cooling circuit hoses, especially, has the advantage of being easily shaped (e.g. by extrusion) just like a thermoplastic composition.

By “elastomeric thermoplastic composition”, it is meant in the present description a TPE material preferably belonging to the ThermoPlastic Vulcanisate (TPV) family, even if the following are alternatively usable:
unvulcanised olefinic TPE (TPE-O or TPO) for example derived from one or more polyolefins (e.g. polyethylenes and propylenes) and a diene or non-diene elastomer (e.g. selected from EPDMs, copolymers of ethylene and at least one linear or branched alpha-olefin having 3 to 20 carbon atoms, such as ethylene-propylene EPM copolymers or octene-ethylene POE copolymers), or even
some styrenic TPEs (TPE-S or TPS) derived from olefins (such as ethylene, propylene or butylene) for TPSs e.g. with SEBS blocks for polystyrene-b-poly(ethylene-butylene)-b-polystyrene, SEPS for polystyrene-b-poly(ethylene-propylene)-b-polystyrene, or SEEPS for polystyrene-b-poly(ethylene-ethylene/propylene)-b-polystyrene.

In general, it will be noted that the combination of ingredients (i) to (v) above makes it possible to confer on the compositions according to the invention satisfactory mechanical properties including secant moduli, shore A hardness, breaking stress and breaking elongation which are each sufficiently high, making it possible to use, in a first embodiment of the invention, only a single layer to form a single-layer hose conveying a fluid at a pressure of no more than 3.0×10⁵ Pa and at a temperature of no more than 120° C., such as a cooling fluid for a low-pressure, low-temperature cooling circuit of a battery or an electric motor of a hybrid or electric automotive vehicle. As will be detailed below, these advantageous properties of a composition according to the invention also make it usable in a multi-layer hose that can incorporate a reinforcing core, according to a second embodiment of the invention.

As elastomer(s) usable in a composition according to the invention of the

TPV type, mention may be made, but not limited to, of diene or non-diene elastomers in a mass fraction of elastomer(s) in the composition of between 10% and 40% inclusive, the elastomers preferably being selected from:
EPDMs,
homopolymers or copolymers of butadiene and/or isoprene (e.g. polybutadiene BR, polyisoprene IR) and optionally further a vinylaromatic comonomer (e.g. styrene for an SBR), acrylonitrile (e.g. for an NBR rubber) or branched alpha-olefin such as isobutylene (e.g. for a butyl IIR rubber),
copolymers of ethylene and at least one linear or branched alpha-olefin with 3 to 20 carbon atoms, such as EPMs or POEs, and
acrylic rubbers of the polyacrylate (ACM) or polyethylene acrylate (AEM) type.

Advantageously, as an elastomer usable in a TPV-type composition according to the invention, an ethylene interpolymer (copolymer or terpolymer, e.g. an EPDM, EPM, POE or AEM) in which the ethylene is bio-based, being of plant origin for example (e.g. derived from cane sugar) can be used.

According to a preferential example of a TPV-type composition according to the invention, at least one EPDM is used as an elastomer, the mass fraction of said at least one elastomer in the composition then being between 15% and 25% inclusive. Furthermore, said at least one EPDM is then advantageously not oil-extended, and can be have:
mass ratios of units derived from ethylene of 40-50%, of an unconjugated diene (such as ethylidene norbornene, ENB) of 8-10%, and preferably
a Mooney viscosity ML (1+4) at 125° C. between 55 and 70.

Advantageously, a TPE-type composition according to the invention (i.e. including TPS, TPO and TPV) may comprise said recycled polyolefin part in a mass fraction greater than 25%, preferably between 28% and 50%, for example between 30% and 45% inclusive.

In the present description, by “recycled polyolefin part” of a TPE-type composition according to the invention (e.g. TPS, TPO or TPV), it is meant one or more polyolefins which are each non-virgin, i.e. which are each derived from “PIR” or “PCR” type recycling (i.e. of a post-industrial (PIR) or post-consumer (PCR) type recycled polyolefin material), or each resulting from milling followed by regeneration in an extruder, for example a twin-screw extruder.

It will be noted that said at least one polyolefin of a TPE-type composition according to the invention (e.g. TPS, TPO or TPV) may comprise said virgin polyolefin part in a mass fraction in the composition between 0% and 50% inclusive, preferably greater than 0% and less than or equal to 40%, as a function of the recycling or regeneration process implemented to obtain said recycled polyolefin part. Further, said virgin polyolefin part may comprise the same polyolefin as said recycled polyolefin part, or another polyolefin.

Advantageously, a TPE-type composition according to the invention (e.g. TPS, TPO or TPV) may comprise said virgin polyolefin part in a mass fraction greater than 10%, preferably between 15% and 35% inclusive.

Also advantageously, a TPE-type composition (e.g. TPS, TPO or TPV) according to the invention may comprise said recycled polyolefin part and said virgin polyolefin part in a total mass fraction between 40% and 70%, preferably between 50% and 68%, for example between 55% and 65% inclusive.

According to another general characteristic of a TPE-type composition according to the invention (e.g. TPS, TPO or TPV), said at least one polyolefin may comprise a homopolymer or interpolymer (e.g. random, segmented or block copolymer) of at least one aliphatic or alicyclic alpha-olefin (such as, but not limited to, propylene or butylene), including an interpolymer of ethylene and at least one alpha-olefin, for example propylene.

According to one exemplary embodiment of a TPE-type composition (e.g. TPS, TPO or TPV), said recycled polyolefin part and optionally said virgin polyolefin part included in said at least one polyolefin each comprise, independently of each other, a homopolymer or a copolymer of propylene, preferably a homopolymer or copolymer of recycled propylene derived from a recycled polyolefin material of the PIR or PCR type, or a regenerated polyolefin material. For example, said at least one polyolefin comprises:
a recycled propylene homopolymer or copolymer (PP), in a mass fraction in said at least one polyolefin of between 50% and 100%, which may be equal to or greater than 75% and less than 100% inclusive, and
a virgin propylene homopolymer or copolymer (PP), in a mass fraction in said at least one polyolefin of between 0% and 50%, which may be greater than 0% and less than or equal to 25% inclusive.

According to an even more preferential example of a TPV-type composition according to the invention, at least one EPDM is used as an elastomer and at least one propylene homopolymer (PP) is used as a polyolefin, with in this case:
the mass fraction of said at least one EPDM in the composition between 15% and 25%, for example between 17% and 22% inclusive, and/or
the mass fraction of the recycled PP between 28% and 50%, for example between 30% and 45% inclusive, and/or
the mass fraction of virgin PP between 15% and 35%, for example between 17% and 32% inclusive, and/or
the total mass fraction of recycled PP and virgin PP between 40% and 70%, for example between 50% and 68% inclusive.

In this description, by “reinforcing filler”, it is generally meant one or more individual fillers of reinforcing grades for an elastomer, which are preferably wholly or partly composed of a reinforcing carbon black and which are homogeneously dispersed in the composition, it being specified that the reinforcing filler may further comprise an organic filler other than carbon black (e.g. graphite) and optionally further comprise an inorganic filler, such as silica or another non-black filler.

Advantageously, said reinforcing filler may comprise a carbon black, which is at least partly optionally recycled and which is for example of ASTM N500 or N600 series, the carbon black being present in the TPE type composition (e.g. TPS, TPO or TPV) in a mass fraction between 1% and 15%, preferably between 4% and 10% inclusive.

It will be noted that this relatively small amount of carbon black in the composition makes it possible especially to confer on a single-layer hose made up of this composition a compromise between a relatively high resistivity and sufficient reinforcement, and thus minimising electrochemical degradation of the hose in contact with the fluid it is conveying when this fluid is a glycol water-type cooling fluid, without compromising the hose resistance to its external environment.

According to another general characteristic of a TPE-type composition according to the invention (e.g. TPS, TPO or TPV) with reference to any of the aforementioned characteristics, the composition may comprise:
said plasticising system in a mass fraction of between 3% and 25%, preferably between 4% and 15%, and for example between 5% and 12% inclusive,
preferably with a mass fraction of carbon black in the composition between 1% and 15%, for example between 4% and 10% inclusive.

As a plasticising system according to the invention, at least one plasticising oil and/or at least one plasticising resin may be used, it being specified that said plasticising system preferably comprises at least one plasticizing oil selected from mineral oils, biomass-derived bio-based oils (including modified or unmodified vegetable oils), and mixtures thereof.

Even more preferentially, as a plasticising system, at least one plasticizing oil selected from paraffinic, naphthenic and aromatic mineral oils is used, e.g. an at least partly naphthenic mineral oil (which may comprise paraffinic, naphthenic and aromatic fractions at the same time).

It will be noted that the said plasticising system used in the reduced mass fraction according to the invention, in comparison with the much higher mass fractions conventionally used in hoses, nevertheless makes the compositions of the invention having the above-mentioned characteristics able to be implemented by mixing and then extrusion, or only by reactive extrusion.

According to another general characteristic of the invention, the composition, in the case where it is of the TPV type, comprises a cross-linking system which is free of phenolic resin and zinc oxide (ZnO) and which preferably comprises an organic peroxide as a cross-linking agent and a cross-linking co-agent selected from triallyl cyanurate (TAC), triallyl isocyanurate (TAIC), and acrylate-based coagents such as ethylene glycol dimethacrylate (EGDMA).

Alternatively, a TPV-type composition according to the invention could comprise a sulfur cross-linking system, optionally in addition to a peroxide cross-linking agent.

Said cross-linking system of a TPV composition according to the invention allows this composition to be chemically cross-linked, preferably by reactive extrusion, and further, because this cross-linking system is completely free of ZnO, it does not inhibit the anti-rust system used in the cooling circuit (ZnO used as a cross-linking activator in the rubber compositions of prior art is known to unfavourably interact with this anti-rust system).

In general, with reference to any of the aforementioned characteristics, said antioxidant system of a TPV-type composition according to the invention may advantageously comprise:
a first, preferably heterocyclic aromatic, antioxidant, for example based on polymerised 2,2,4-trimethyl-1,2-dihydroquinoline, and
a second, thioether-based, antioxidant, for example distearyl disulphide, and preferably said antioxidant system further comprises a third antioxidant based on an aromatic amine.

It will be noted that this mixed and preferably ternary antioxidant system advantageously allows the TPV compositions according to the invention to be given improved mechanical properties after thermal ageing in air and in glycol water, in comparison with mechanical properties of a reference TPV composition of similar formulation but in which said at least one polyolefin is entirely virgin (i.e. is not at least partly recycled).

According to other characteristics of the TPV-type compositions according to the invention, these compositions may have:
a continuous phase comprising said at least one polyolefin, and a discontinuous phase comprising nodules of said at least one elastomer (for example at least one EPDM) which are dispersed in said at least one polyolefin, and
a breaking stress and breaking elongation, measured in uniaxial tensile testing according to standard ISO 37:2017 after ageing for 3000 hours at 120° C. in contact with air and glycol water, respectively, which are higher than the breaking stress and breaking elongation of said reference TPV composition where said at least one polyolefin is, for example, composed of a virgin propylene homopolymer.

According to another general aspect of the invention with reference to any of the aforementioned characteristics, the TPE-type compositions according to the invention (e.g. TPS, TPO or TPV) can be prepared by mixing in an internal mixer followed by twin-screw extrusion, or alternatively by a single reactive twin-screw extrusion step.

According to another general aspect of the invention with reference to any of the aforementioned characteristics, an elastomer or elastomer-textile or metal composite article according to the invention comprises or consists of an extrudate formed of a TPE-type composition according to the invention (e.g. TPS, TPO or TPV), the article being selected in particular from single-layer hoses, multi-layer hoses optionally reinforced with a textile core, gaskets for motor vehicles or for buildings, anti-vibration devices and elements for the support, chocking or protection of battery packs or data processing centres.

Advantageously and in a non-limited way, the article can be an extruded single-layer or multi-layer hose for a cooling circuit of a battery or an electric motor of an electric or hybrid automotive vehicle, preferably a single-layer hose which is made up of said TPE-type composition (e.g. TPS, TPO or TPV) and which is usable to convey a cooling fluid from a battery at a pressure of at most 3.0. 10⁵ Pa and at a temperature of at most 120° C.

As explained above, the mechanical properties of the TPE composition and therefore of the single-layer hose that can be made therefrom are sufficient for it to convey a cooling fluid under these temperature and pressure conditions with good dynamic performance. Single-layer hoses according to said first embodiment of the invention can thus have reduced inner and outer diameters compared to reinforced hoses of prior art, which consequently appear oversized for a low pressure and low temperature circuit. As a result, the manufacturing cost of hoses according to said first embodiment of the invention is significantly reduced relative to known reinforced hoses for automotive cooling systems.

A hose according to a second embodiment of the invention is of the multi-layer type, comprising a radially inner layer, a radially outer layer and optionally a reinforcing core (e.g. textile or metal), with the inner layer and/or the outer layer consisting of a TPE-type composition according to the invention (e.g. TPS, TPO or TPV) as defined above, with reference to any of the aforementioned characteristics.

As a reinforcing core, at least one textile or non-textile reinforcement core overlying the inner layer can be used (e.g. a core made of knitted, braided or covered yarns for example of PET, aramid or rayon).

A hose according to said second embodiment of the invention can be used for the transfer of a liquid, gaseous or supercritical fluid at a pressure that can exceed 3. 10⁵ Pa and/or at a temperature that can exceed 120° C.

It will be noted that a hose according to this second embodiment of the invention may further comprise a barrier layer of a plastic material, based on at least one thermoplastic polymer. This barrier layer can form the radially innermost layer of the hose, or an ‘insulating layer’ between the inner tube and a reinforcement layer or between the inner tube and an intermediate layer.

A fluid circuit according to the invention, in particular for cooling a battery or an electric motor for a hybrid or electric motor vehicle, comprises a plurality of single-layer and/or multi-layer hoses mounted to connectors, for example thermoplastic connectors, and it can be characterised in that at least one (and preferably each) of the hoses is as defined above.

In the present description, by the term “based on”, it is meant that the composition or ingredient in question predominantly comprises the constituent in question by weight, i.e. in a mass fraction of more than 50%, preferably more than 75% and up to 100%.

The invention also concerns a thermoplastic elastomer composition, in particular usable in a single-layer (1) or multi-layer (10, 20, 30, 40) hose of a cooling circuit of a battery or an electric motor of an electric or hybrid automotive vehicle, the composition comprising:

(i) at least one elastomer,
(ii) at least one polyolefin comprising
a recycled polyolefin part derived from “PIR” or “PCR” type recycling (i.e. of a post-industrial (PIR) or post-consumer (PCR) type recycled polyolefin material), or resulting from milling followed by regeneration in an extruder, and
optionally a virgin polyolefin part,
   (iii) a reinforcing filler comprising carbon black,
   (iv) a plasticising system comprising at least one plasticising oil and/or at least one plasticising resin, and
   (v) an antioxidant system comprising several antioxidants (at least 2 antioxidants), one being a thioether based antioxidant, wherein the composition comprises, in mass fractions:
more than 35% of said at least one polyolefin, and
less than 30% of said plasticising system.

### BRIEF DESCRIPTION OF THE DRAWINGS

Further characteristics, advantages and details of the invention will become apparent upon reading the following description of several exemplary embodiments of the invention, given by way of illustration in connection with the attached drawings, including:

FIG. 1 is a schematic side perspective view of a single-layer hose according to the invention.

FIG. 2 is a schematic side perspective view with partial cutaways of a multi-layer hose according to one example of the invention.

FIG. 3 is a schematic side perspective view with partial cutaways of a multi-layer hose according to another example of the invention.

FIG. 4 is a schematic side perspective view with partial cutaways of a multi-layer hose according to another example of the invention.

FIG. 5 is a schematic side perspective view with partial cutaways of a multi-layer hose according to another example of the invention.

FIG. 6 is an atomic force microscope (AFM) picture illustrating morphology of a reference composition not in accordance with the invention.

FIG. 7 is an AFM picture illustrating morphology of a first composition according to the invention.

FIG. 8 is an AFM picture illustrating morphology of a second composition according to the invention.

FIG. 9 is a stress-strain graph, before ageing, of said reference composition and said second composition according to the invention.

FIG. 10 is a stress-strain graph after thermal ageing in glycol water, of said reference composition and said second composition according to the invention.

FIG. 11 is a stress-strain graph after thermal ageing in air, of said reference composition and said second composition according to the invention.

FIG. 12 is a stress-strain graph, before ageing, of said reference composition and compositions according to the invention.

### DETAILED DESCRIPTION

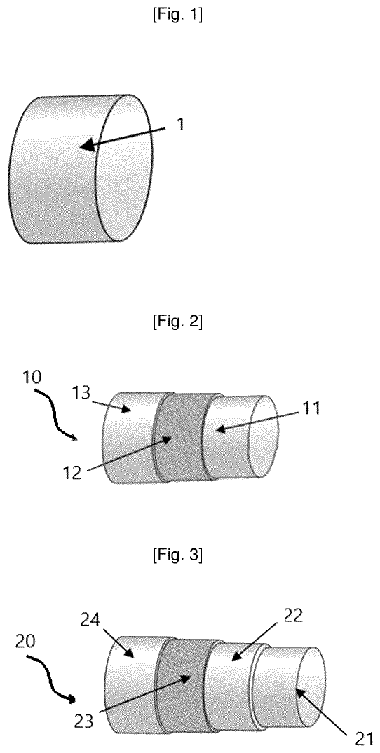

The single-layer hose 1 of FIG. 1 is able to convey a fluid such as a cooling fluid, at a pressure of no more than 3. 10⁵ Pa and a temperature of no more than 120° C., and it can be assembled to two connectors, for example thermoplastic connectors. This hose 1 consists of a TPE composition according to the invention (e.g. TPS, TPO or TPV) as defined above.

The multi-layer hose 10 of FIG. 2 is able to convey any fluid such as those aforementioned, at a pressure that can be equal to or greater than 3. 10⁵ Pa, and it comprises a radially inner tube 11, a reinforcing layer 12 and a radially outer coating layer 13, it being specified that at least one of the tube 11 and the coating layer 13 consists of a TPE composition according to the invention (e.g. TPS, TPO or TPV) as defined above.

The reinforcement layer 12 may comprise, in a non-limited way, a knitted, braided or covered fabric based on multifilament yarns made of one or more textile materials, for example polyamide (e.g. aramid), polyester (e.g. PET) or rayon (the term ‘yarn’ usually designating both a spun yarn made from a multitude of small diameter elementary filaments twisted together, and a fold yarn obtained by twisting several spun yarns).

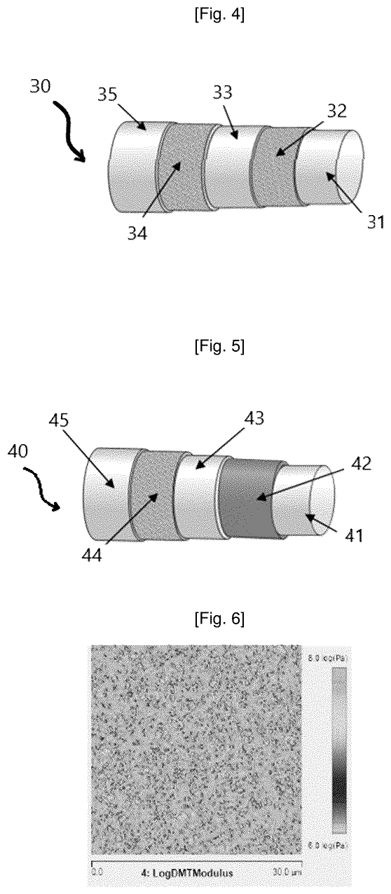

The multi-layer hose 20 of FIG. 3 differs from that of FIG. 2 in that the inner tube 21 is overlaid with an intermediate layer 22, which is itself overlaid with a reinforcing layer 23 covered with a coating layer 24, it being specified that at least one of the tube 21 and the coating layer 24 consists of a TPE composition according to the invention.

The multi-layer hose 30 of FIG. 4 differs from that of FIG. 3 in that the inner tube 31 is overlaid with an inner reinforcement layer 32, which is itself overlaid with an intermediate layer 33 covered with an outer reinforcement layer 34 and then a coating layer 35, it being specified that at least one of the tube 31, the intermediate layer 33 and the coating layer 35 consists of a TPE composition according to the invention.

The multi-layer hose 40 of FIG. 5 differs from that of FIG. 3 in that the inner tube 41 is overlaid with a barrier layer 42 of plastic material forming an insulating layer, and then an intermediate layer 43 covered with a reinforcing layer 44, itself overlaid with a coating layer 45, it being specified that at least one of the tube 41, the intermediate layer 43 and the coating layer 45 consists of a TPE composition according to the invention.

It will be noted that a multi-layer hose according to the invention could comprise an arrangement of layers differing from those illustrated in FIGS. 2-5, both in terms of the number of its layers and their respective functions.

Preparation of reference composition C1, first composition I1 according to the invention and second composition I2 according to the invention:

Three thermoplastic vulcanisates (TPV) compositions have been prepared, forming the reference composition C1 and the first and second compositions I1 and I2 according to the invention respectively, for example able to constitute a single-layer hose for a cooling circuit, by implementing the following preparation method.

Firstly, a mixing step has been implemented in an internal mixer, with the incorporation of the ingredients listed below into the mixing cycle (first the elastomer, polyolefin, processing agents and plasticising system, then the cross-linking system and finally the antioxidant system at the end of the cycle), with the temperature rising due to shearing to a plateau at 200° C. for 8 minutes.

Secondly, a step of extruding the mixture recovered has been implemented in a twin-screw extruder at 190° C.

Each of the three TPV compositions C1, I1 and I2 obtained in this way has then been shaped into dumbbell-type test pieces with size H2 for the measurement of mechanical properties in the cross-linked state (stress/strain curves and resulting breaking properties). These properties have thus been measured in uniaxial tensile testing at 23° C. according to standard ISO 37:2017 in the initial state, and then after two types of thermal ageing.

Table 1 below details the formulation of composition C1 (in parts by weight of each ingredient in the composition) thus prepared.

TABLE 1

| Ingredients | | C1 |
|---|---|---|
| EPDM with an ethylene mass ratio of 44% and ENB of 9%, and | | 60 |
| ML(1 + 4) at 125° C. of 63 | | |
| Polypropylene: “PPH3060” | | 170 |
| Cross-linking agent: alkylphenol formaldehyde resin | | 4 |
| Activator: ZnO | | 3 |
| Processing agents | PEG | 5 |
| | Stearic acid | 0.5 |
| | Fatty acids | 1 |
| | lubricant | 1 |
| Carbon black: ASTM N500 series | | 22 |
| Plasticiser: mineral oil of the formula [Chem. 1] below | | 24.8 |
| Antioxidant | Aromatic amine of the formula [Chem. 2] | 1.5 |
| | below | |
| | alkyl-dihydroquinoline | 1 |

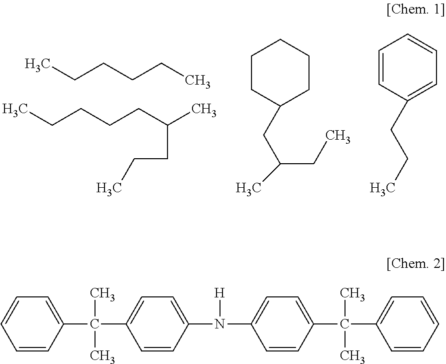

Table 2 below details the formulation of compositions I1 and I2 (in parts by weight of each ingredient in the composition) thus prepared.

TABLE 2

| Ingredients | | I1 | I2 |
|---|---|---|---|
| EPDM with an ethylene mass ratio of 44% and ENB of 9%, | | 60 | 60 |
| and ML(1 + 4) at 125° C. of 63 | | | |
| Polypropylene (PP) with recycled (rPP) and virgin (vPP) | | 195 | 170 |
| fractions: | | | |
| For 11: PIR with 50% mass of recycled PP “PRC50UFO | | | |
| black” | | | |
| For 12: PCR with 70% mass of recycled PP “rPP1002” | | | |
| Cross-linking agent: bis-alkylperoxide | | 2.4 | 2.4 |
| Cross-linking co-agent: acrylate-based | | 1.2 | 1.2 |
| Processing agent: PEG | | 5 | 5 |
| Carbon black: ASTM N500 series | | 22 | 22 |
| Plasticiser: mineral oil of the formula [Chem. 1] | | 24.8 | 24.8 |
| Antoxidants | Aromatic amine of the formula [Chem. 2] | 1.5 | 1.5 |
| | alkyl-dihydroquinoline | 1 | 1 |
| | Thioether: distearyl disulphide | 1 | 1 |

Composition I1 thus contains 195 parts by weight of a post-industrial recycled (i.e. “PIR” type) polyolefin material named ‘PRC50UFO black’, comprising:
50% by weight of recycled polypropylene rPP, predominantly comprising propylene homopolymer or copolymer, i.e. 97.5 parts by weight of rPP, and

50% by weight of other ingredients that may predominantly comprise virgin polypropylene vPP (propylene homopolymer or copolymer, identical or different from that of rPP), and at least one additive (such as an antioxidant, for example) present in trace amounts, i.e. 97.5 parts by weight of these other ingredients.

The mass fractions of rPP and vPP in composition I1 are therefore each about 31%, while the respective mass fractions of EPDM, carbon black and plasticiser in composition I1 are 19%, 7% and 8% respectively.

Composition I2 thus contains 170 parts by weight of a post-consumer recycled (i.e. ‘PCR’ type) polyolefin material named ‘rPP 1,002’, comprising:
70% by weight of recycled polypropylene rPP, predominantly comprising a propylene homopolymer or copolymer, i.e. 119 parts by weight of rPP, and
30% by weight of other ingredients that may predominantly comprise virgin polypropylene vPP (propylene homopolymer or copolymer, identical or different from that of rPP), and at least one additive (such as an antioxidant, for example) present in trace amounts, i.e. 51 parts by weight of these other ingredients.
   The mass fractions of rPP and vPP in composition I2 are therefore about 41% and 18% respectively, while the respective mass fractions of EPDM, carbon black and plasticiser in composition I2 are 21%, 8% and 9% respectively.

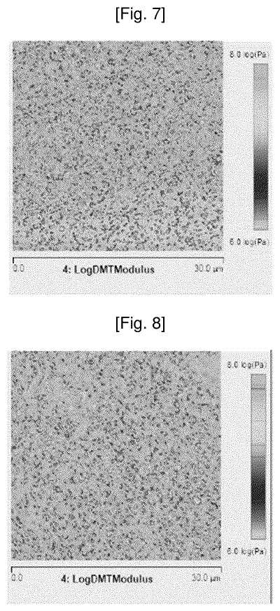

As illustrated in the pictures in FIGS. 6-8, the atomic force microscope (AFM) morphological analyses show, for each of the three compositions C1, I1 and I2, that the polyolefin thermoplastic phase (PP) is continuous and that the elastomer phase (EPDM) has a structure of elastic nodules dispersed in the rigid matrix of this continuous polyolefin phase. These pictures further show a reduction in the mean size of the elastomer nodules in compositions I1 and I2 according to the invention, in comparison with composition C1.

It has been verified that the rheological and extrudability properties of compositions I1 and I2 according to the invention were similar to those of the reference composition C1.

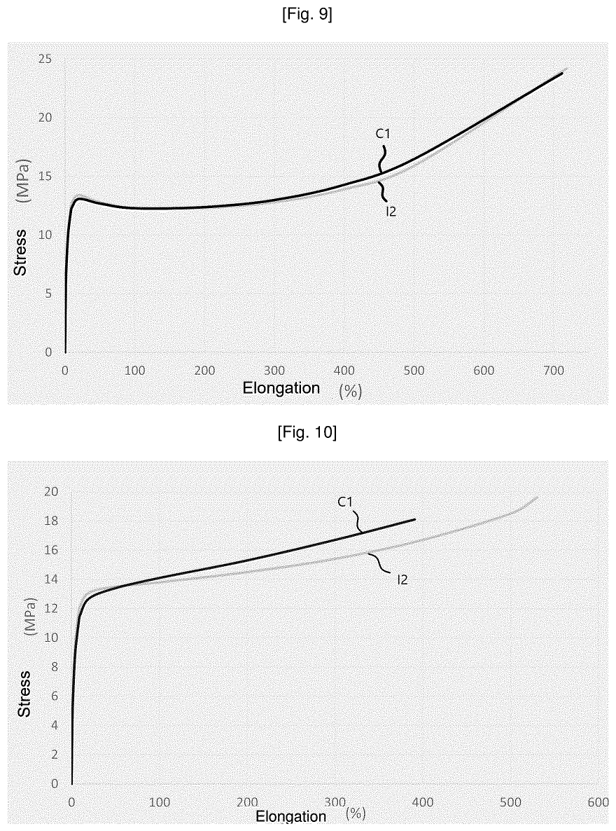

And as indicated above, uniaxial tensile tests have been carried out at 23° C. according to standard ISO 37:2017 on H2 test pieces made up of compositions C1 and I2, in the initial state (i.e. before any exposure of the compositions to fluids and operating conditions characterising their operation), the results of which are visible in the stress/strain curves of FIG. 9.

As illustrated in FIG. 9, it has been verified that the mechanical tensile properties and, in particular, the breaking properties of composition I2 were similar to those of composition C1 in the initial state (see the quasi-superimposition of curves for I2 and C1 from low to high strains).

These uniaxial tensile tests have then been carried out again according to standard ISO 37:2017 on H2 test pieces made up of compositions C1 and I2, but after two separate thermal ageing cycles, respectively in contact with a cooling fluid made up of glycol water and in contact with air.

As illustrated in FIG. 10, after thermal ageing in immersion at 120° C. in a 50%/50% water/glycol solution for a period of 3000 hours, it has been verified that the tensile properties (measured at 23° C.) and in particular the breaking properties of composition I2 were improved relative to those of composition C1 (see curve for I2 reflecting lower stresses for given strains, from 80% relative strain, relative to stresses applied to composition C1 for the same strains, and maximum stresses higher for I2 than for C1 at the highest strains).

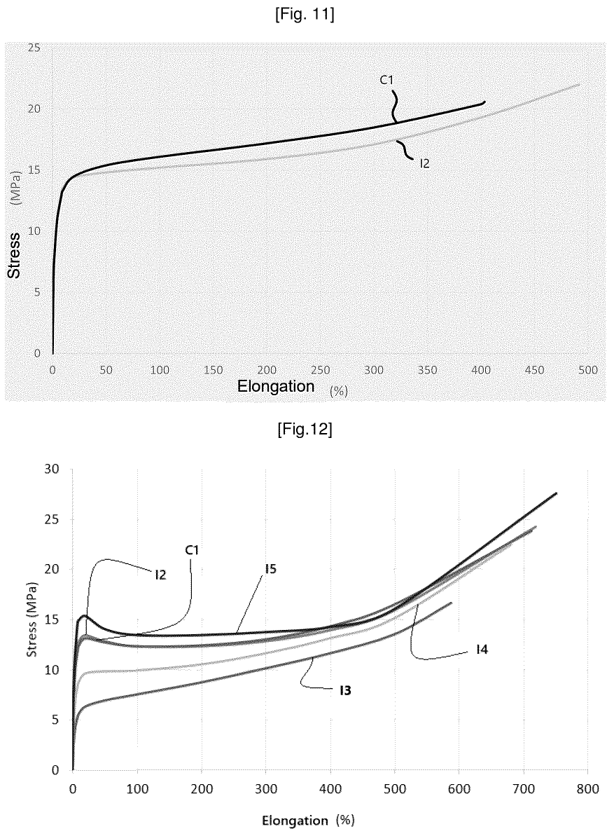

As illustrated in FIG. 11, after thermal ageing in air at 120° C. for a period of 3000 hours, it has been verified that the tensile properties (measurements at 23° C.) and in particular the breaking properties of composition I2 were also improved relative to those of composition C1 (see curve for I2 reflecting lower stresses for given strains, from 30% relative strain, relative to the stresses applied to composition C1 for the same strains, and maximum stresses higher for I2 than for C1 at the highest strains).

In conclusion, compositions I1 and I2 according to the invention, which are especially characterised in that they comprise a durable polyolefin (e.g. a recycled polypropylene) in a mass fraction greater than 30%, or even greater than 40% (composition I2), and therefore have a reduced carbon footprint relative to the reference composition (carbon footprint reduced by 29% for composition I1 and 30% for composition I2), have a similar and even improved resistance to thermal ageing (cf. composition I2) relative to composition C1, both in contact with a glycol fluid and with air, which demonstrates the suitability and even the superiority of compositions according to the invention to form, especially, a single-layer pipe or the inner and/or outer layers of a multi-layer pipe for a cooling circuit of a battery or an electric motor of an automotive vehicle.

It will be noted that this resistance to thermal ageing, which is analogous and even improved for the compositions according to the invention, is especially made possible by the aforementioned mixed antioxidant system, comprising a first, preferably heterocyclic aromatic, antioxidant and a second, thioether-based, antioxidant, in addition to the other ingredients of the compositions of the invention.

It will also be noted that, as the compositions of the invention are free of zinc oxide, they favourably do not interact with the anti-rust system used in the cooling circuit, which anti-rust system is thus not inhibited and fully ensures its protective function.

Preparation of composition I3 to I5 according to the invention:

Compositions I3 to I5 according to the invention have been prepared according to the protocol mentioned above. The quantity of Polypropylene (PP) with recycled (rPP) and virgin (vPP) fractions have been varied in the different compositions. Table 3 below details the formulation of compositions I3 to I5 (in parts by weight of each ingredient in the composition) thus prepared.

TABLE 3

| Ingredients | | I3 | I4 | I5 |
|---|---|---|---|---|
| EPDM with an ethylene mass ratio of 44% and ENB | | 60 | 60 | 60 |
| of 9%, and ML(1 + 4) at 125° C. of 63 | | | | |
| Polypropylene (PP) with recycled (rPP) and virgin | | 80 | 120 | 210 |
| (vPP) fractions: | | | | |
| PCR with 70% mass of recycled PP “rPP1002” | | | | |
| Cross-linking agent: bis-alkylperoxide | | 2.4 | 2.4 | 2.4 |
| Cross-linking co-agent: acrylate-based | | 1.2 | 1.2 | 1.2 |
| Processing agent: PEG | | 5 | 5 | 5 |
| Carbon black: ASTM N500 series | | 22 | 22 | 22 |
| Plasticiser: mineral oil of the formula [Chem. 1] | | 24.8 | 24.8 | 24.8 |
| Antoxidants | Aromatic amine of the formula | 1.5 | 1.5 | 1.5 |
| | [Chem. 2] | | | |
| | alkyl-dihydroquinoline | 1 | 1 | 1 |
| | Thioether: distearyl disulphide | 1 | 1 | 1 |

The mass fractions of rPP and vPP are as follows:
in composition I3, about 28% of rPP and 12% of vPP,
in composition I4, about 35% of rPP and 15% of vPP,
in composition I5, about 50% of rPP and 20% of vPP.

Uniaxial tensile tests have been carried out at 23° C. according to standard ISO 37:2017 on H2 test pieces made up of compositions I3, I4 and I5, in the initial state (i.e. before any exposure of the compositions to fluids and operating conditions characterising their operation), the results of which are visible in the stress/strain curves of FIG. 12.

As illustrated in FIG. 12, the results show that the compositions according to the invention have breaking and elongation properties that are satisfactory.

1. A thermoplastic elastomer composition, in particular usable in a single-layer or multi-layer hose of a cooling circuit of a battery or an electric motor of an electric or hybrid automotive vehicle, the composition comprising:
(i) at least one elastomer,
(ii) at least one polyolefin comprising a recycled polyolefin part and optionally a virgin polyolefin part,
(iii) a reinforcing filler,
(iv) a plasticising system, and
(v) an antioxidant system,
wherein the composition comprises, in mass fractions:
more than 35% of said at least one polyolefin, and
less than 30% of said plasticising system.

2. The composition according to claim 1, wherein the composition comprises said recycled polyolefin part in a mass fraction greater than 25%, preferably between 28% and 50%, for example between 30% and 45% inclusive.

3. The composition according to claim 1, wherein the composition comprises said virgin polyolefin part in a mass fraction greater than 10%, preferably between 15% and 35% inclusive.

4. The composition according to claim 3, wherein the composition comprises said recycled polyolefin part and said virgin polyolefin part in a total mass fraction of between 40% and 70%, preferably between 50% and 68%, for example between 55% and 65% inclusive.

5. The composition according to claim 1, wherein the composition comprises said plasticising system in a mass fraction between 3% and 25%, preferably between 4% and 15%, and for example between 5% and 12% inclusive.

6. The composition according to claim 1, wherein said at least one polyolefin comprises:
a homopolymer of at least one alpha-olefin, for example propylene, or
an interpolymer of ethylene and at least one alpha-olefin, for example propylene, said recycled polyolefin part preferably comprising a recycled propylene homopolymer or copolymer derived from a post-industrial recycled (PIR) or post-consumer recycled (PCR) polyolefin material, and for example wherein said recycled polyolefin part and said virgin polyolefin part respectively comprise, independently of each other:
a recycled propylene homopolymer or copolymer (PP), in a mass fraction in said at least one polyolefin between 50% and 100% inclusive, and
a virgin propylene homopolymer or copolymer (PP), in a mass fraction in said at least one polyolefin between 0% and 50% inclusive.

7. The composition according to claim 6, wherein the composition is a thermoplastic vulcanisate (TPV), said at least one elastomer being selected from
EPDMs,
homopolymers or copolymers of butadiene and/or isoprene, and further optionally a vinylaromatic comonomer, acrylonitrile or a branched alpha-olefin,
copolymers of ethylene and at least one linear or branched alpha-olefin having 3 to 20 carbon atoms, and
acrylic rubbers of the polyacrylate (ACM) or polyethylene acrylate (AEM) type, preferably wherein said at least one elastomer is selected from ethylene-propylene-diene terpolymers (EPDM), butyl rubbers (IIR) and octene-ethylene copolymers (POE), and
preferably wherein the mass fraction of said at least one elastomer in the composition is between 10% and 40% inclusive.

8. The composition according to claim 7, wherein the composition comprises a cross-linking system which is free from phenolic resin and zinc oxide and which preferably comprises an organic peroxide as a cross-linking agent and a cross-linking coagent selected from triallyl cyanurate (TAC), triallyl isocyanurate (TAIC), and acrylate-based coagents such as ethylene glycol dimethacrylate (EGDMA).

9. The composition according to claim 7, wherein said at least one elastomer is an ethylene-propylene-diene terpolymer (EPDM) whose ethylene is optionally bio-based, and
preferably wherein the mass fraction of said at least one elastomer in the composition is between 15% and 25% inclusive.

10. The composition according to claim 1, wherein said reinforcing filler comprises a carbon black which is optionally at least partly recycled and which is for example of the ASTM N500 or N600 series, said carbon black being present in the composition in a mass fraction of between 1% and 15%, preferably between 4% and 10% inclusive.

11. The composition according to claim 1, wherein said antioxidant system comprises:
a first, preferably heterocyclic aromatic, antioxidant, for example based on polymerised 2,2,4-trimethyl-1,2-dihydroquinoline, and
a second, thioether-based, antioxidant, for example distearyl disulphide, and preferably wherein said antioxidant system further comprises a third antioxidant based on an aromatic amine.

12. The composition according to claim 9, wherein the composition forming said thermoplastic vulcanisate (TPV) comprises a continuous phase comprising said at least one polyolefin, and a discontinuous phase comprising nodules of said at least one elastomer which are dispersed in said at least one polyolefin, and
wherein the composition has a breaking stress and breaking elongation, measured in uniaxial tensile testing according to standard ISO 37:2017 after ageing for 3000 hours at 120° C. in contact with air and glycol water, respectively, which are higher than the breaking stress and breaking elongation of a reference thermoplastic vulcanisate composition where said at least one polyolefin, free of recycled polyolefin part, consists of a virgin propylene homopolymer (PP).

13. The composition according to claim 1, wherein said plasticising system comprises at least one oil selected from mineral oils, biomass-derived bio-based oils such as modified or unmodified vegetable oils, and mixtures thereof, and for example, wherein said at least one oil is selected from paraffinic, naphthenic and aromatic mineral oils.

14. An elastomer or elastomer-textile or metal composite article, in particular selected from single-layer hoses (1), multi-layer hoses (10, 20, 30, 40) optionally reinforced by a textile core (12, 23, 32, 34, 44), gaskets for motor vehicles or for buildings, anti-vibration devices and elements for the support, chocking or protection of battery packs or data processing centres,
wherein the article comprises or consists of an extrudate formed of a composition according to claim 1.

15. The article according to claim 14, wherein the article is an extruded single-layer or multi-layer hose for a cooling circuit of a battery or an electric motor of an electric or hybrid automotive vehicle, and preferably wherein
the article is a single-layer hose (1) which consists of said composition and which is usable to convey a cooling fluid from a battery at a pressure of at most 3.0. 10⁵ Pa and at a temperature of at most 120° C.
